(19) United States
(12) Patent Application Publication
(10) Pub. No.: US 2007/0129050 A1
(43) Pub. Date: Jun. 7, 2007

(54) Mobile communication terminal with display shortcut key and method of enabling the same

(76) Inventor: Jae Hak Ryu, Kyunggi-do (KR)

Correspondence Address: FENWICK & WEST LLP, SILICON VALLEY CENTER, 801 CALIFORNIA STREET, MOUNTAIN VIEW, CA, 94041, US

(21) Appl. No.: 11/603,734

(22) Filed: Nov. 21, 2006

(30) Foreign Application Priority Data
Nov. 24, 2005 (KR) 10-2005-0112656

(51) Int. Cl. H04Q 7/20; H04M 11/00

(52) U.S. Cl. 455/403

(57) ABSTRACT

A mobile communication terminal with a display shortcut key and a method of enabling the same is provided. In the mobile communication terminal, when a display key button is switched on, which select a function of the display key button to be performed and a display image to be displayed on the display key button from a menu which enables the function of the key button and the display image to be selected, and register the function of the display key button and the display image in a database, and thereby may perform the registered communication terminal.

### CROSS-REFERENCE TO RELATED APPLICATION

This application claims the benefit of Republic of Korea Patent Application No. 10-2005-0112656, filed on Nov. 24, 2005, in the Korean Intellectual Property Office, the disclosure of which is incorporated herein by reference.

### BACKGROUND OF THE INVENTION

1. Field of the Invention

The present invention relates to a mobile communication terminal with a display shortcut key and a method of enabling the same.

2. Description of the Related Art

A mobile communication terminal is widely used as a device which enables people to communicate with each other regardless of a location in modem society. As recent developments in mobile communication terminal technologies have improved processor performance and resource memories have been increased, mobile communication terminal provides various functions in various fields as well as conventional mobile communication services.

Currently, a mobile communication terminal includes many functions such as a camera function, a MP3, a radio receiver function, etc. Accordingly, users have to follow a complex process in order to select a function that they want to use. In this instance, users select a function by checking a menu on a display screen and pushing digits on a keypad, which is relatively complex and takes a significant amount of time to become accustomed to using the function.

FIG. 1 is a diagram illustrating a print key button to control a mobile communication terminal according to a conventional art. As shown in FIG. 1, digits, special characters, and Korean and alphabetic characters (not shown) are printed on a keypad 110 according to the conventional art. A user may use a function by pushing key buttons on the keypad 110. Accordingly, the user has to push at least several buttons to use the function that the user wants to use. Also, although the user may designate a shortcut key on a program, designating the shortcut key every time is inconvenient and annoying.

Moreover, a wireless Internet service has led to an increase in a diversity of information that users may access, and a demand for the wireless Internet service has surged. Also, functions and services using a mobile communication terminal may be limitlessly diversified. Therefore, a mobile communication terminal with a display shortcut key in which users may easily and simply start a function with, and a method of enabling the same is greatly desired.

### SUMMARY OF THE INVENTION

The present invention provides a mobile communication terminal with a display shortcut key, which includes a display key button to be displayed according to a registered display image, and is able to perform a corresponding shortcut function, in order to perform a particular function by using the display shortcut key in the mobile communication terminal.

The present invention also provides a key button operation method, in which a user selects and registers a shortcut function of a display key button and an image to be displayed from a menu, in order to perform the registered shortcut function when the display key button is switched on.

According to an aspect of the present invention, there is provided a mobile communication terminal including: at least one display key button performing at least one registered function when the display key button is registered and switched on; and a database storing and managing images for registering the at least one display key button, and an image and a function of the at least one display key button.

In this instance, the at least one display key button performs a shortcut function with respect to at least two menu paths which are provided in the mobile communication terminal.

Also, the mobile communication terminal further comprises a key button function setting unit registering a function to be performed when the display key button is switched on, in the database through a registration menu of the display key button.

Also, the mobile communication terminal further comprises a display image setting unit registering an image which is selected from the images for registering the at least one display key button through a registration menu of the display key button, as an image to display on the display key button.

According to another aspect of the present invention, there is provided a key button operation method in a mobile communication terminal including: executing a registration menu of a display key button; selecting at least one function from the executed menu, and registering the selected at least one function as a function of the display key button; and selecting an image for the display key from the executed menu, and registering the selected image as an image to display the display key button.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a diagram illustrating a print key button to control a mobile communication terminal according to a conventional art;

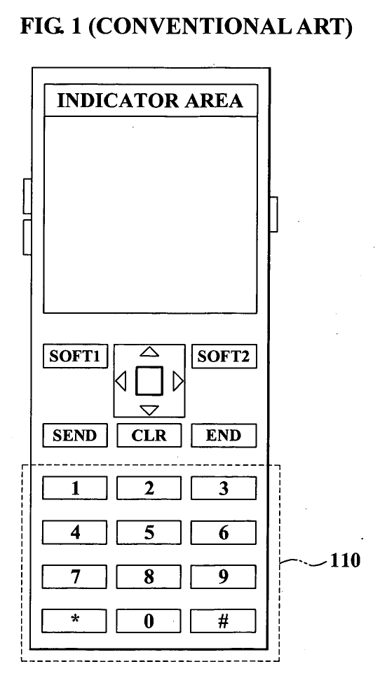

FIG. 2 is a block diagram illustrating a mobile communication terminal according to an embodiment of the present invention;

FIG. 3 is a diagram illustrating an example of the mobile communication terminal of FIG. 2;

FIG. 4 is a flowchart illustrating operating processes of a mobile communication terminal according to an embodiment of the present invention;

FIG. 5 is a diagram illustrating an example of a configuration of a database which is automatically generated according to a utilization frequency of a display shortcut key according to an embodiment of the present invention; and

FIG. 6 is a diagram illustrating an example of a key button function and display image which are embodied in a mobile communication terminal according to a configuration of the database of FIG. 5.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

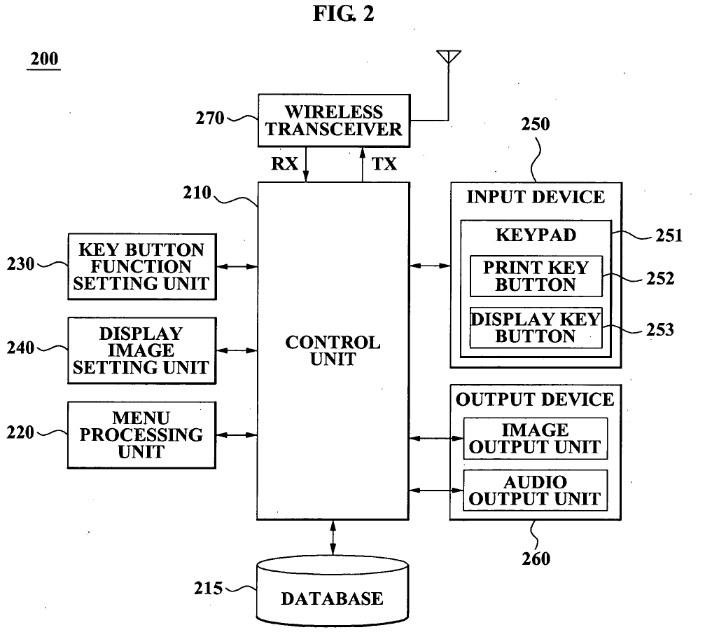

FIG. 2 is a block diagram illustrating a mobile communication terminal 200 according to an embodiment of the present invention.

As shown in FIG. 2, the mobile communication terminal 200 includes a control unit 210, a database 215, a menu processing unit 220, a button function setting unit 230, a display image setting unit 240, an input device 250, a keypad 251 including a print key button 252 and a display key button 253, an output device 260, and a wireless transceiver 270.

The mobile communication terminal 200 enables various display images for generating the display key button 253 and a shortcut function of the display key button 253 to be registered in a form of a menu. Also, the mobile communication terminal 200 is proposed so that the display images and the shortcut functions, which are selected by a user, are performed. The user selects a function of a corresponding display key button 253 to be performed through a predetermined menu for registering the display key 253, when the display key 253 is switched on. Also, the user registers the selected function in the database 215 as the function of a corresponding display key button 253. Also, the user selects any one of images for the display key button 253, and registers the selected image in the database 215 as an image for displaying the corresponding display key button 253. Accordingly, when the registered display key button 253 is switched on, the function of the registered display key 253 may be performed.

The control unit 210 controls each unit of the mobile communication terminal 200. Also, the control unit 210 generally includes a processor function which processes all data in the communication terminal 200 associated with a Digital Signal Processor (DSP). When the DSP for processing an internal signal such as a baseband signal is sufficiently included, operations for each mode may be quickly processed due to a rapid processing speed. Also, the control unit 210 may be used including a Mobile Station Modem (MSM), the DSP, and an Open Multimedia Application Platform (OMAP).

The database 215 stores and manages images for the display key button 253 and an image and function of the registered display key button 253. A non-volatile dynamic random access memory (NV-DRAM) may be used as the database 215. The NV-DRAM may embody both a fast writing feature of a DRAM and a non-volatile feature of a flash memory. The function of the display key button 253 and the display images which are stored in the database 215 may be registered through a menu which is displayed by the menu processing unit 220 on the output device 260.

The menu processing unit 220 may provide at least one control command with respect to a key button function and a plurality of display images, in the form of the menu. In this instance, the key button function is performed when the display key button 253 is switched on, and the plurality of display images is displayed on the display key button 253. Accordingly, the user may select the key button function and display images that the user wants to use, through the menu, and set user's own display key button 253.

Also, the menu processing unit 220 enables a corresponding menu to display through several steps, like in a text message writing, a game executing, a photographing, or a wireless Internet access. In this instance, in order to execute menu paths in which the user has navigated through so far by using the shortcut function, the menu processing unit 220 selects an execution of the menu paths and a corresponding display image from a sub-menu of a current menu, and may establish the display key button 253.

Also, when the plurality of display key buttons 253 are provided, the menu processing unit 220 may provide a menu for determining which display key button corresponds to the selected key button function and display image.

When a corresponding function is selected from a registration menu of the display key button 253, the key button function setting unit 230 registers the function of the corresponding display key button 253 in the database 215. In this instance, the function of the corresponding display key button 253 is performed when the display key button 253 is switched on. Also, the key button function includes a text message mode, a speaker volume setting mode, a display setting mode, a multimedia mode, a scheduler mode, an environment setting mode, a telephone book mode, a camera mode, etc. Also, sub-functions of the above-mentioned modes, for example, “the text message writing mode” under the text message mode, “lock setting mode” or “password setting mode” under the environment setting mode, and the like, may be registered.

When a corresponding image is selected from the registration menu of the display key button 253, the display image setting unit 240 registers the corresponding image for the display key button 253 in the database 215. In this instance, the corresponding image for the display key button 253 is registered as an image which displays the corresponding display key button 253. A character from many different languages, a symbol, a digit, and a picture may be used as the display image.

Also, an output sound may be provided for a visually impaired person, since the visually impaired person may not use the registration menu described above. Specifically, an audio output unit may be included to output a predetermined sound, when the display key button 253 is switched on. Also, the predetermined sound may be a guide message for the key button function which is performed when the display key button 253 is switched on.

The input device 250 is a means for controlling various functions of the mobile communication terminal 200 to be performed. The input device 250 may include at least one of a keypad, a touch screen, a touch pad, and a voice recognition module. Particularly, in the present invention, the display key button 253 which is registered by the user, as well as the print key button 252 may be used as input means.

The display key button 253 may be a plastic key having a feature of light beam penetration to visibly output the display image which is selected by the user from the registration menu. Specifically, the selected display image may be projected in a form of a light from lower area of an inside of the display key button 253 to an upper area of the inside of the display key button 253. Also, a backlight or a light emitting diode (LED) may be used as an illuminant by installing the backlight or the LED under the display key button 253. Although it has been described that the display key button 253 is used together with the print key button 252 in this specification, the keypad 251 which is comprised of only the display key button 253 may be embodied.

A device providing a graphic interface may be used as the output device 260 in order to select the key button function and display image with respect to the display key button 253 which are based on the database 215, from the menu. The registered key button function is performed when the registered display key button 253 is switched on. Also, the output device 260 may include at least one of an image output unit, an audio output unit, and a haptic output unit. In this instance, a liquid crystal display (LCD), the LED, an organic LED (OLED), and a plasma display panel (PDP) may be used as the image output unit. A speaker, and an earphone which are capable of outputting various sounds such as a bell sound, a coloring service, and a Moving Picture Experts Group Audio-Layer 3 (MP3) encoded files, may be used as the audio output unit. The haptic output unit utilizing a vibrating motor, and the like may be used as the output device 260.

The wireless transceiver 270 transmits/receives radio wave with a base station while performing a mobile communication service. Also, in the present invention, the wireless transceiver 270 may be used as a device for wirelessly transmitting/receiving data when the display key button 253 is used for utilizing a wireless internet service.

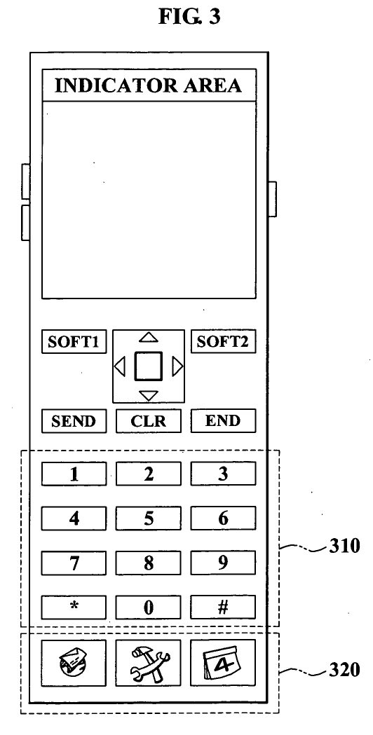

FIG. 3 is a diagram illustrating an example of the mobile communication terminal of FIG. 2.

As shown in FIG. 3, the mobile communication terminal 200 includes a keypad including at least one print key button 310, and a display key button 320 according to the present invention. Each print key button 310 is a fixed keypad in which digits or characters on each key button cannot be erased. Conversely, each display image of the display key button 320 may be changed according to a user's choice.

In FIG. 3, only three display key buttons 320 are included. However, more than three display key buttons 320 may be included, and every key button in the keypad may be comprised of only the display key buttons 320. Accordingly, when the digits or characters on the print key button 310 are replaced with the display images, the display images may be changed to Korean characters, alphabetic characters or other foreign characters, and thereby allowing many nationalities to easily use the display key button 320. Also, when playing a mobile game, the display key button 320 may be used as a game button, and thereby allowing game users to efficiently use the display key button 320. The display key button 320 of FIG. 3 illustrates an example of a message service button, an environment setting button, and a schedule button from the left to the right.

Accordingly, the users may easily recognize a function of each display key button 320 by visually confirming the display image on the display key button 320. Also, the users may use the function that the user wants to use by merely pushing the display key button 320, not by going through several steps.

According to another embodiment of the present invention, when the registered display key button 320 is not used for a predetermined period, the display image or the key button function may be converted to a predetermined display image or a predetermined key button function. Specifically, when the user does not use the display key button 320 for a relatively long period of time, the mobile communication terminal automatically reassigns the function of the display key button 320 in order to improve efficiency of the display key button 320. As an example, the display image or key button function may be reassigned into a most frequently used display image or key button function.

Hereinafter, a key button operation method of the mobile communication terminal which has been described by referring to FIGS. 2 and 3 will be described.

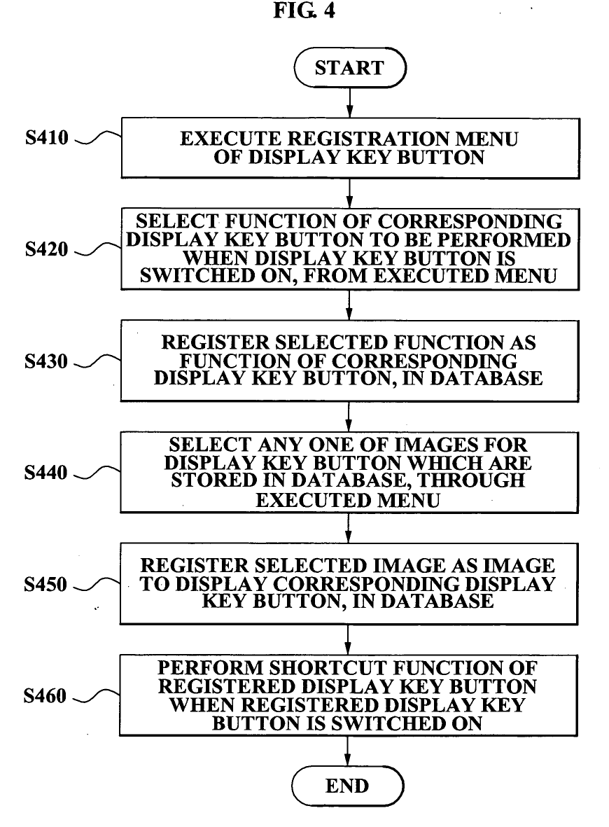

FIG. 4 is a flowchart illustrating operating processes of a mobile communication terminal according to an embodiment of the present invention.

In operation S410, the mobile communication terminal 200 executes a registration menu of a display key button 253. In operation S420, the mobile communication terminal 200 selects a function of a corresponding display key button 253 to be performed when the display key button 253 is switched on, from the executed menu. In this instance, the function of the display key button 253 and display images, which are stored in the database 215, may be provided to a user by a menu processing unit 220 in a form of a menu.

Also, the function of the display key button 253 may be registered in a menu in which the user has navigated through so far. For example, in order to perform a menu path in which the user has navigated through, as a shortcut function, an execution of the menu path may be selected as the function of the display key button 253 in a sub-menu of a current menu.

In operation S430, the selected function is registered through the key button function setting unit 230 in the database 215 as the function of the corresponding display key button 253.

In operation S440, the mobile communication terminal 200 selects any one of images for the display key button 253 which are stored in the database 215, through the executed menu. The images which can be used as the display key button 253 may be Korean characters, alphabetic characters, or other foreign characters. Also, the display key button 253 can be used as a game button for a game user. In operation S450, the selected image is registered as an image to display the corresponding display key button 253, in the database 215. Accordingly, the database 215 may store and manage images for registering the display key button 253 and the function of the registered display key button 253.

In operation S460, the shortcut function of the registered display key button 253 may be performed when the registered display key button 253 is switched on. When a configuration for the visually-handicapped is embodied, an output sound may be provided. In this instance, when the display key button 253 is switched on, a predetermined sound is outputted and the output sound may be selected by the user in the form of the menu. The predetermined sound may be a guide message for the key button function which is performed when the display key button 253 is switched on.

The key button operation method according to the above-described embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configure to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configure to act as one or more software modules in order to perform the operations of the above-described embodiments of the present invention.

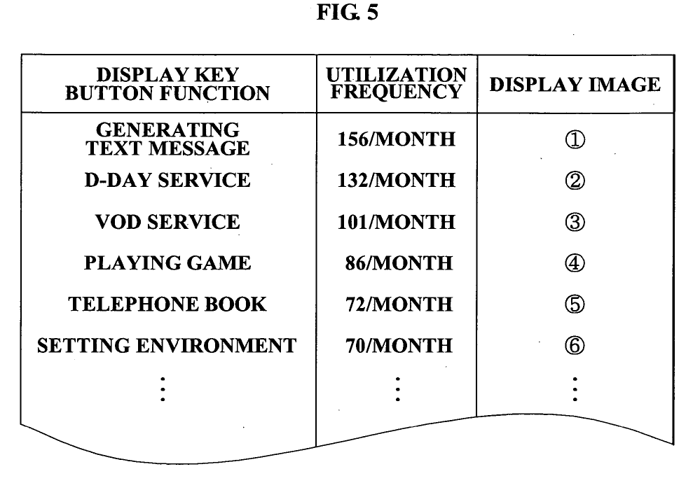

FIG. 5 is a diagram illustrating an example of a configuration of a database which is automatically generated according to a utilization frequency of a display shortcut key according to an embodiment of the present invention.

Referring to FIG. 5, a function of the display key button 253 may be automatically figured based on a utilization frequency of each function of the display key button 253 which is used by a user in a mobile communication terminal 200. Statistics for a month, a day, and an hour are calculated based on the figure utilization frequency, and a most frequently used function may be arranged according to a reference which is set by the user. Statistics illustrated in FIG. 5 is database information in which a utilization frequency per month is sorted in a descending order.

Accordingly, the function of the display key button 253 is automatically assigned to the display key button 253 according to the utilization frequency, and thereby increasing the user's convenience.

Also, the display images which are provided in the database 215 may be automatically assigned to the display key button 253 according to the utilization frequency.

The display images in FIG. 5 may be used as a group. Specifically, the display images may be automatically arranged, focusing on the most frequently used display image among various display images such as characters, digits, symbols, and pictures,. As another example, a picture of a flower such as a tulip, a picture of an animal such as a cat, a picture of a mascot such as Mickey Mouse, and the like, may be used as the display images.

Also, when a plurality of display key buttons 253 are included in the mobile communication terminal 200, the function and the display images of the display key button 253 may be automatically assigned to the display key buttons 253 in an order of highest utilization frequency. As an example, based on FIG. 5, when three functions and display images of the display key buttons 253 are automatically assigned, the three display key buttons 253 may be positioned as an upper button, a center button, and a lower button according to a location. When the user uses the lower button most frequently, the mobile communication terminal 200 displays the display image \textcircled{1} on the lower button. Also, when the user pushes the lower button, ‘writing a text message’ may be immediately performed as the function of the display key button 253. When the user uses the center button second most frequently, the mobile communication terminal 200 displays the display image \textcircled{2} on the center button, and the center button is automatically set to move to ‘D-Day service’. When the user uses the upper button third most frequently, the mobile communication terminal 200 displays the display image \textcircled{3} on the upper button, and the upper button is automatically set to move to ‘VOD service’.

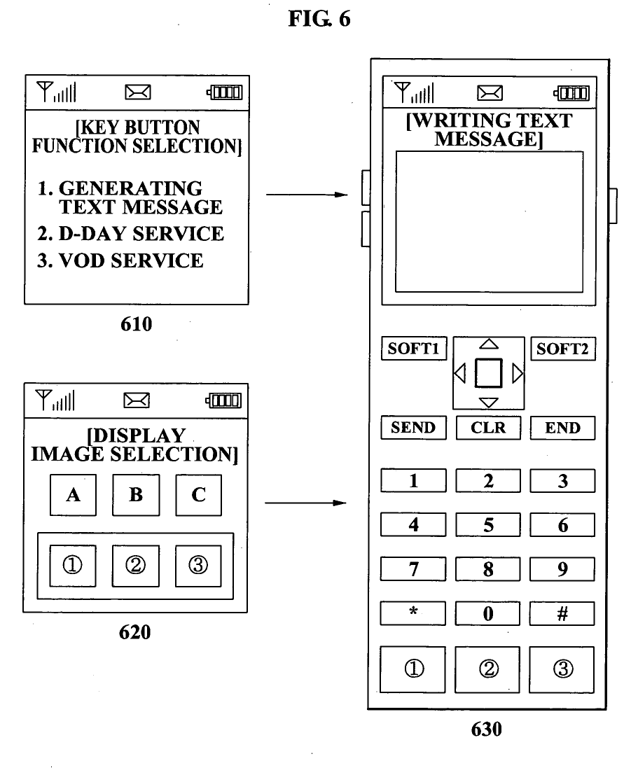

FIG. 6 is a diagram illustrating an example of a key button function and display image which are embodied in a mobile communication terminal according to a configuration of the database of FIG. 5.

Referring to FIG. 6, the mobile communication terminal 200 may automatically set key button functions as shown in a screen 610 in FIG. 6, in the database 215, or set display images as shown in a screen 620 in FIG. 6. Also, the key button functions and the display images as shown in the screen 610 and the screen 620 in FIG. 6 may be manually set by a user. Specifically, a key button function selection list may be provided in a form of a menu as shown on the screen 610, so that the user edits a function of display key button 253. The key button function selection list may provide the key button function which is automatically arranged based on a utilization frequency. Also, the user may randomly select a service that the user wants to use, and may designate any one of the provided key button functions for the selected service.

Also, the user may select a display image which is provided in a display image selection menu. The screen 620 in FIG. 6 illustrates a selection menu of a group image, which may select the display image for each group. Specifically, the display key button 253 may be displayed such as ‘A’, ‘B’, and ‘C’ in English characters or \textcircled{1}, \textcircled{2}, and \textcircled{3} in digits. Also, as shown in the display key button 320 in FIG. 3, each display image may be provided for each key button, respectively. Accordingly, in a screen 630 in FIG. 6, the display images corresponding to each of the \textcircled{1}, \textcircled{2}, and \textcircled{3}, which are selected in the display image selection, are displayed on the display key buttons 253 of the mobile communication terminal 200.

Also, according to another embodiment of the present invention, a plurality of display key buttons 253 are included, and the plurality of display key buttons 253 may be used by combining at least two key buttons. Accordingly, another key button function may be performed. Specifically, as shown in the screen 630, when only three display key buttons 253 are included, the use of the display key buttons 253 may be broaden by simultaneously pushing two buttons of the display key buttons 253, for example, the key button \textcircled{1} and the key button \textcircled{2}, the key button \textcircled{2}and the key button \textcircled{3}, or the key button \textcircled{3} and the key button \textcircled{1}. Also, when the two display key buttons 253 are simultaneously switched on, the display image which is displayed on each of the display key buttons 253 may be varied. As an example, when a mobile game is performed by simultaneously pushing the key button \textcircled{1} and the key button \textcircled{2}, display images associated with a game may be simultaneously displayed on each of the display key buttons 253 or a predetermined sound may be outputted.

Also, according to another embodiment of the present invention, the display key buttons 253 may be used as a shortcut key for the mobile game. As an example, a battle type game usually requires a complex manipulation. Accordingly, when setting various key buttons for the battle type game as the display key buttons 253, the user may play the game more conveniently by using the display key buttons 253.

According to the present invention, when a user pushes a display key button on a mobile communication terminal, a shortcut key function corresponding to a display image of the display key button is performed, and thereby allowing the user to easily use a function that the user want to use.

Also, according to the present invention, a user may randomly replace a display image by selecting the display image from a menu. Accordingly, a display key button may be varied according to the user's taste.

Also, according to the present invention, a utilization frequency of a function which is provided in a mobile communication terminal is automatically figure, and a key button function and display image of a display key button may be automatically generated based on a predetermined reference. Accordingly, a user may easily use the display key button without designating each display key button.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A mobile communication terminal comprising:
at least one display key button performing at least one registered function when the display key button is registered and switched on; and
a database storing and managing images for registering the at least one display key button, and an image and a function of the at least one display key button.

2. The mobile communication terminal of claim 1, wherein the at least one display key button performs a shortcut function with respect to at least two menu paths which are provided in the mobile communication terminal.

3. The mobile communication terminal of claim 1, further comprising:
a key button function setting unit registering a function to be performed when the display key button is switched on, in the database through a registration menu of the display key button.

4. The mobile communication terminal of claim 1, further comprising:
a display image setting unit registering an image which is selected from the images for registering the at least one display key button through a registration menu of the display key button, as an image to display on the display key button.

5. The mobile communication terminal of claim 1, wherein the function of the display key button is automatically assigned based on a utilization frequency of each of the key button functions which are provided in the mobile communication terminal.

6. The mobile communication terminal of claim 1, wherein the image of the display key button is automatically assigned based on a utilization frequency of each of the images which are provided in the database.

7. The mobile communication terminal of claim 1, wherein the at least one display key button includes a plurality of display key buttons, and a key button function or a display image of each of the plurality of display key buttons is automatically assigned based on a utilization frequency of key button functions or display images of the plurality of display key buttons.

8. The mobile communication terminal of claim 1, wherein a display image or a key button function of the registered display key button is converted into a predetermined display image or a key button function, when a registered display key button is not used during a predetermined period.

9. The mobile communication terminal of claim 8, wherein the converted display image or key button function is a most frequently used display image or key button function.

10. The mobile communication terminal of claim 1, comprising:
an audio output unit outputting a predetermined sound, when the display key button is switched on.

11. The mobile communication terminal of claim 10, wherein the sound is a guide message for a key button function which is activated when the display key button is switched on.

12. The mobile communication terminal of claim 1, wherein the at least one display key button includes a plurality of display key buttons, and the plurality of display key buttons perform another function by combining at least two key buttons.

13. A key button operation method in a mobile communication terminal comprising:
executing a registration menu of a display key button;
selecting at least one function from the executed menu, and registering the selected at least one function as a function of the display key button; and
selecting an image for the display key from the executed menu, and registering the selected image as an image to display the display key button.

14. A computer-readable recording medium storing a program for implementing a key button operation method in a mobile communication terminal comprising:
executing a registration menu of a display key button;
selecting at least one function from the executed menu, and registering the selected at least one function as a function of the display key button; and
selecting an image for the display key from the executed menu, and registering the selected image as an image to display the display key button.
